(19) United States
(12) Patent Application Publication
(10) Pub. No.: US 2004/0030830 A1
(43) Pub. Date: Feb. 12, 2004

(54) Storage medium control method, storage medium control device, and storage medium adaptor

(75) Inventor: Masahiko Shimizu, Yokohama-shi (JP)

Correspondence Address: PILLSBURY WINTHROP, LLP, P.O. BOX 10500, MCLEAN, VA, 22102, US

(73) Assignee: Tokyo Electron Device Limited, Yokohama-shi (JP)

(21) Appl. No.: 10/638,299

(22) Filed: Aug. 12, 2003

Related U.S. Application Data
(63) Continuation of application No. PCT/JP01/01400, filed on Feb. 26, 2001.

(51) Int. Cl. G06F 12/00

(52) U.S. Cl. 711/115; 711/170; 711/154

(57) ABSTRACT

A storage medium control method carried out in a storage medium control device, inserted between a storage medium and a host apparatus accessing the storage medium, is provided. The method controls signal lines connected between the storage medium control device and the storage medium in a detachable manner, and the timing of signals on the signal lines. In the method, functional information of the signal lines used to control the storage medium and state information of the signals on the signal lines are read from first storage means, in accordance with the type of the storage medium. Then, the timing of the signals passing between the storage medium and the storage medium control device is controlled based on an operation clock and the state information, in response to an operation request supplied from the host apparatus.

### CROSS REFERENCE

This patent application is a continuation application based on PCT/JP01/01400 filed Feb. 26, 2001, the entire contents of which are incorporated herein by reference.

### BACKGROUND OF THE INVENTION

1. Field of the Invention

The present invention relates to a storage medium control technique, and more particularly to a storage medium control method, a storage medium control device, and a storage medium adaptor, which are suitable for controlling various types of attachable/detachable storage media.

2. Description of Related Art

Use of memory cards is increasing and spreading widely, which memory cards are used as attachable and detachable storage media. Memory cards generally comprises flash memories, and there are many types of memory cards existing, such as Smart Media cards, secure digital (SD) cards, MMCs (multi media cards), and compact flash cards. In actual use, a memory card is inserted into a corresponding type of memory card slot in order to allow data to be written to and read from the memory card.

However, there is no compatibility between different types of memory cards. Accordingly, in order to use an arbitrary type of memory card in an electronic apparatus, such as a personal computer, a PDA, or a digital camera, a memory card slot suitably designed for that type of memory card is required. To overcome this inconvenience, a memory card adaptor is provided so as to allow a memory card to be used as if it were a particular type of memory card.

Alternatively, a reader and writer device may be used. The reader and writer device is connected to a personal computer or other electronic apparatuses via an interface, including a SCSI (small computer system interface) or a USB (universal serial bus), in order to allow data to be written to or read from a particular memory card.

The above-described memory card slots, memory card adaptors, and reader/writer devices generally have a memory card controller, which functions as a storage medium control device for controlling writing and reading data to and from the memory card. Such a memory card controller is prepared for each of the corresponding types of memory cards treated in the memory card slot, the memory card adaptor, or the reader/writer device.

In recent years, memory card slots, memory card adaptors, and reader/writer devices have been brought into practical use, and therefore, the memory card controller has to be designed so as to deal with different types of memory cards. It is also desired for the memory card controller to be capable of dealing with various types of memory cards due to the relatively large size of the minimum economical production run.

In order to respond to this demand, the circuit structure of a memory card controller becomes complicated, and IC chips including a huge number of components are used. However, when using such IC chips in a memory card controller, electric power consumption increases. This means that the conventional memory card controller is unsuitable for a notebook-type personal computer, or a PDA. In addition, because of the complicated circuit structure of the conventional memory card controller, the manufacturing cost increases. Still another problem is that it is very difficult to add or modify control timing to an already manufactured memory card.

### SUMMARY OF THE INVENTION

The present invention was conceived to overcome the above-described problems in the prior art, and it is an object of the invention to provide a storage medium control method, a storage medium control device, and a storage medium adaptor, which are capable of defining each bit of data used to control an arbitrary type of attachable/detachable storage medium, to which it is easy to add or modify control timing, which operates with a low power consumption, and which are inexpensive and suitable for general purpose use.

To achieve the object, in one aspect of the invention, a storage medium control method carried out in a storage medium control device inserted between a storage medium and a host apparatus that accesses this storage medium is provided. This method is suitable for controlling signal lines connected between the storage medium control device and the storage medium in a detachable manner, as well as the timing of signals on the signal lines. The method comprises the steps of:

reading functional information of the signal lines used to control the storage medium, and state information of the signals on the signal lines, from first storage means in accordance with a type of the storage medium; and

controlling the timing of the signals passing between the storage medium and the storage medium control device, based on an operation clock and the state information, in response to an operation request supplied from the host apparatus.

The functional information of the signal lines and the state information of the signals on the signal lines form state control information. This state control information defines the function of each of the signal lines and a state of each of the signals passing through the signal lines by each bit.

The timing control step includes specifying a start address of the state information in response to the operation request from the host apparatus, and determining a function and an input and output direction of each of the signals, based on the operation clock and the state information with the start address specified.

In another aspect of the invention, a storage medium control device inserted between a storage medium and a host apparatus that accesses this storage medium is provided. The storage medium control device controls signal lines connected to the storage medium in a detachable manner, as well as the timing of signals on the signal lines. The device comprises:

a first storage that stores functional information of the signal lines used to control the storage medium, and state information of the signals on the signal lines, in association with the type of the storage medium; and

a timing controller that controls the timing of the signals passing between the storage medium and the storage medium control device based on an operation clock and the state information, in response to an operation request supplied from the host apparatus.

The functional information of the signal lines and the state information of the signals on the signal lines form state control information. This state control information defines the function of each of the signal lines and a state of each of the signals on the signal lines by each bit.

The storage medium control device further comprises start address specifying means connected to the first storage means and for specifying a start address of the state information, in response to the operation request from the host apparatus, and control signal specifying means for determining a function and an input and output direction of each of the signals based on the operation clock and the state information with the start address specified.

In still another aspect of the invention, a storage medium adaptor electrically connected between a storage medium and a host apparatus that accesses this storage medium is provided. The storage medium adaptor controls signal lines connected to the storage medium in a detachable manner, and the timing of signals on the signal lines. The storage medium adaptor comprises:

a first connector that receives the storage medium in a removable manner;

a second connector that establishes connection with the host apparatus;

a first storage that stores functional information of the signal lines used to control the storage medium, and state information of the signals on the signal lines, in association with the type of the storage medium; and

a timing controller that reads the functional information of the signal lines and the state information of the signals from the first storage, and controls the timing of the signals passing between the storage medium and the host apparatus based on an operation clock and the state information, in response to an operation request supplied from the host apparatus.

The functional information of the signal lines and the state information of the signals on the signal lines form state control information. This state control information defines the function of each of the signal lines and a state of each of the signals on the signal lines by each bit.

The storage medium adaptor further comprises start address specifying means connected to the first storage and for specifying a start address of the state information, in response to the operation request from the host apparatus, and control signal specifying means for determining a function and an input and output direction of each of the signals based on the operation clock and the state information with the start address specified.

### BRIEF DESCRIPTION OF THE DRAWINGS

Other objects, features, and advantages of the invention will become more apparent from the following detailed description when read in conjunction with the accompanying drawings, in which

FIG. 1 illustrates a structure of the memory card controller according to an embodiment of the invention;

FIG. 2 illustrates an example of a set of card control codes used for a Smart Media card;

FIG. 3 is a timing chart used to explain interface timing of the Smart Media card;

FIG. 4 illustrates an example of connection between a memory card controller and various types of memory cards;

FIG. 5 illustrates another example of connection between a memory card controller and various types of memory cards;

FIG. 6 illustrates an example of allocation of functions to signal lines for different types of memory cards;

FIG. 7 is a sequence diagram showing the operation process of the memory card controller;

FIG. 8 illustrates an example of the card adaptor according to the present invention;

FIG. 9 illustrates another example of the card adaptor according to the present invention; and

FIG. 10 illustrates the structure of a memory card controller according to another embodiment of the present invention.

### DETAILED DESCRIPTION OF THE PREFERRED EMBODIMENTS

The details of the present invention will now be described below with reference to the attached figures.

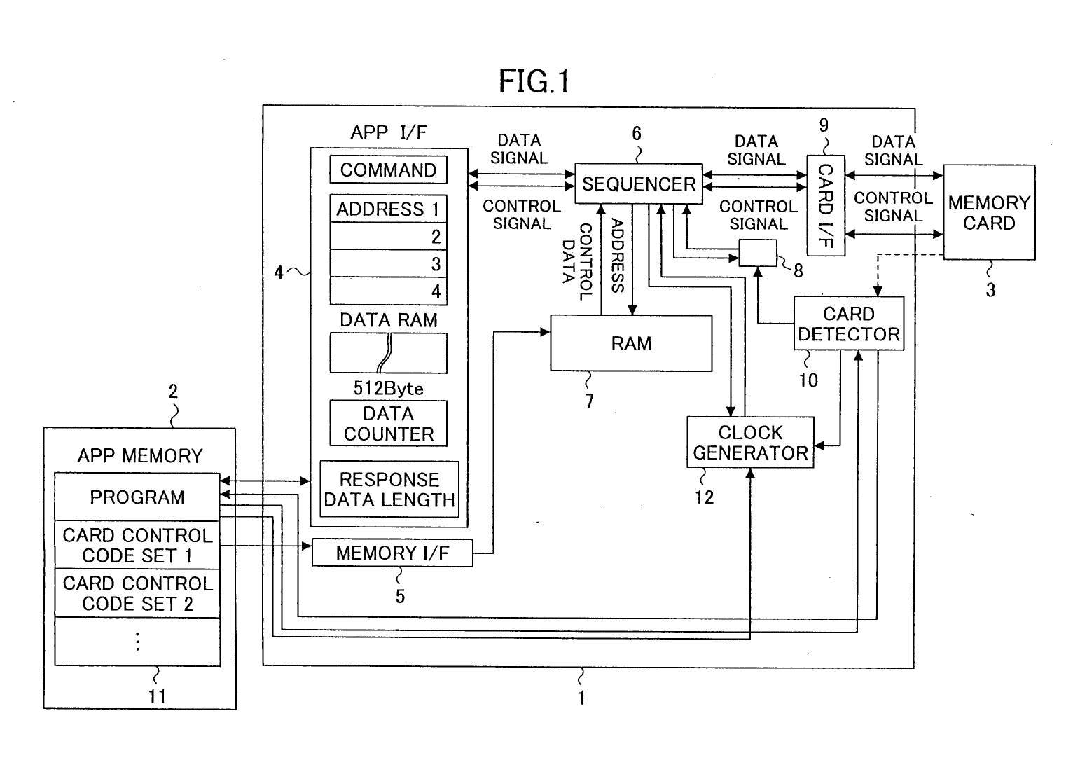

FIG. 1 illustrates the structure of the memory card controller 1 according to an embodiment of the present invention. In order to facilitate comprehension of the present invention, explanation is made focusing on the operations of the memory card controller 1.

The memory card controller 1, which is an example of a storage medium control device, has a register 4 functioning as an application interface, a memory interface (hereinafter, referred to as “memory I/F”) 5, a sequencer 6, a RAM (random access memory) 7, input/output data bit control unit 8, a card interface (hereinafter, referred to as “card I/F”) 9, a card detector 10, and a clock generator 12. The memory card controller 1 is assembled into, for example, a memory card slot, a memory card adaptor, or a reader and writer device.

Host 2 is an electronic apparatus, such as a personal computer, a PDA, or a digital camera, that outputs a command for reading data from the memory card 3, or a command for writing data into the memory card 3. The host 2 has an application memory (hereinafter, referred to as “App memory”) 11. The memory card 3 is, for example, a Smart Media card, an SD card, an MMC, or a compact flash card.

The application memory (App memory) 11 stores a program and one or more sets of card control codes. Each set of card control codes is prepared corresponding to a specific type of memory card 3, for which the memory card controller 1 performs reading and writing control of the data. For instance, if the memory card 3 is a Smart Media card or an SD card, the card control code set (1) illustrated in FIG. 1 is used. If the memory card 3 is an SD card, then the card control code set (2) illustrated in FIG. 1 is used.

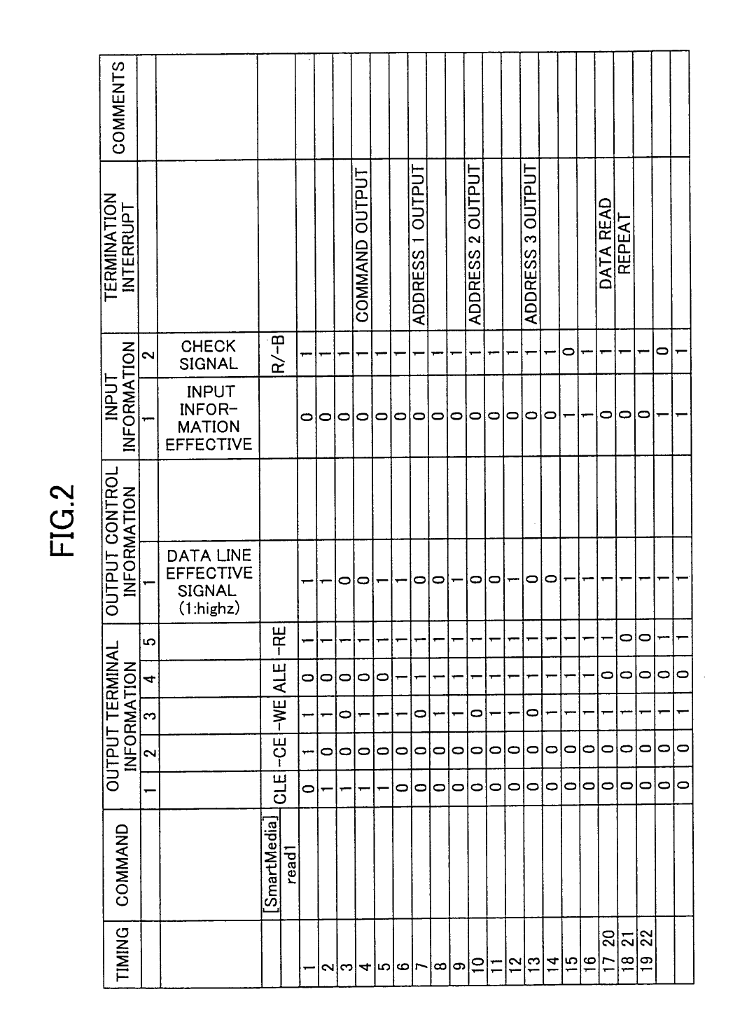

The card control codes define interface timings of the memory card 3 by each bit of data. FIG. 2 illustrates an example of the card control code set for the Smart Media card. The example shown in FIG. 2 illustrates only the card control code set for the “read1” command. However, of course, control codes corresponding to other commands are also stored as the card control code set (1) in the App memory 11.

In FIG. 2, the card control code set includes output terminal information, output control information, and input information. The output terminal information includes a command line enable signal “CLE”, a chip enable signal “-CE”, a write enable signal “-WE”, an address line enable signal “ALE”, and a read enable signal “-RE”. These signals are supplied through the associated signal lines extending from the control signal output terminals of the controller 1 to the memory card 3.

The output control information includes a data line effective signal, which controls the direction of the data signal transmitted through the card I/F 9, the sequencer 6, and the register 4. For example, if the output control information is at a low level, the data signal of the register 4 is supplied to the memory card 4 via the sequencer 6 and the card I/F 9. When the output control information is at a high level, the data signal of the memory card 3 is supplied to the register 4 via the card I/F 9 and the sequencer 6.

The input information includes an input information effective signal, which is used to take the control signal of the memory card 3 into the sequencer 6. For instance, if the input information is at a high level, the busy signal R/-B of the memory card 3 is supplied via the card I/F 9 to the sequencer 6, which signal is used to check the status of the memory card 3.

In FIG. 2, time passes from timing 1 to timing 19. The command line enable signal “CLE” included in the output terminal information changes “0111100 . . . ” as time passes. The timing numbers contained in the card control code set shown in FIG. 2 are illustrated only for the purpose of convenience for explanation, and these numbers are not necessarily required.

All or a portion of each set of card control codes stored in the App memory 11 of the host 2 are selected in accordance with the instruction from the program. The selected card control codes are supplied via the memory I/F 5 to the RAM 7 of the memory card controller 1. The host 2 supplies commands, addresses, and data to the register 4 of the memory card controller 1. The register 4 stores commands, addresses, data, data counter, response data length and other information.

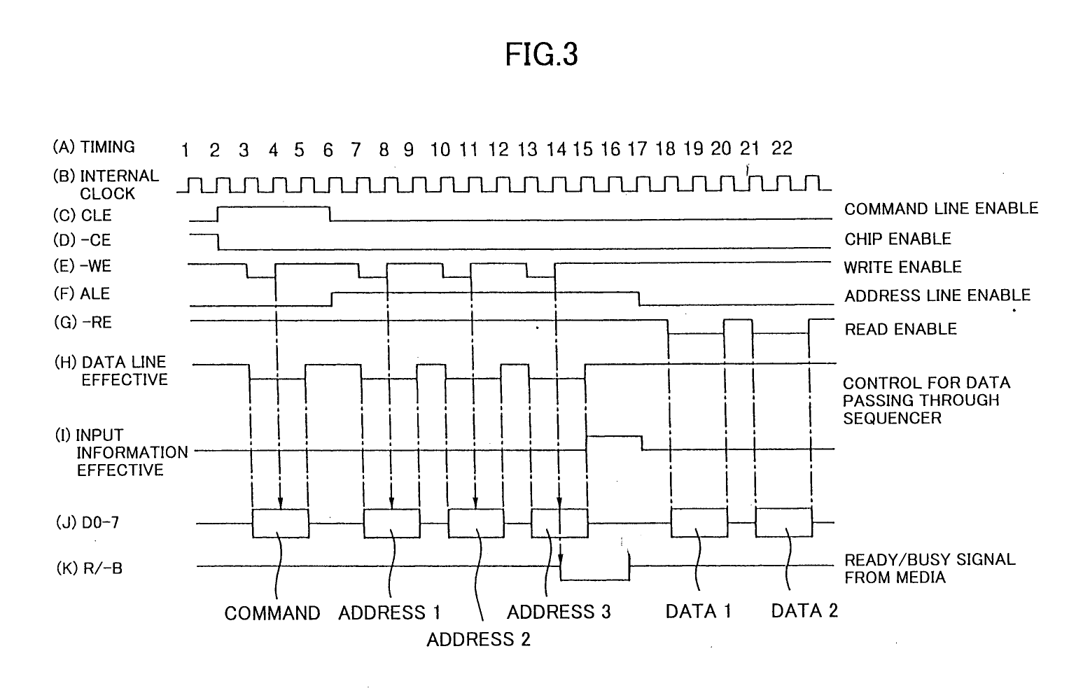

The sequencer 6 supplies the address unambiguously determined from the command of the resister 4 to the RAM 7, and successively reads the set of card control codes corresponding to that command. Then, the sequencer 6 outputs signals generated in accordance with the card control codes read from the RAM 7 to the card I/F 9. For example, if the command supplied from the register 4 is “read1”, the sequencer 6 reads the card control codes shown in FIG. 2 successively from the RAM 7. Then signals (C) through (K) illustrated in FIG. 3 are transmitted between the sequencer and the memory card 3 via the card I/F 9.

FIG. 3 is a timing chart showing various interface timings for the Smart Media card. The timing numbers shown in FIG. 3(A) timing match the timings of FIG. 2. The internal clock (B) is used in the memory card controller 1.

The pulse signals (C) through (I), which represent the command enable signal “CLE”, the chip enable signal “- CE”, the write enable signal “-WE”, the address line enable signal “ALE”, the read enable signal “-RE”, the data line effective signal, and the input information effective signal, respectively, are supplied as control signals from the sequencer 6 to the card I/F 9, based on the card control code set shown in FIG. 2.

The input information effective signal (I) and the busy signal R/-B (K) are supplied from the memory card 3 to the card I/F 9. The data signal (J) is used to transmit commands, addresses, and data between the sequencer 6 and the memory card 3 via the card I/F 9, in response to the write enable signal -WE, the read enable signal -RE, and the data line effective signal, which are illustrated as pulse signals (E), (G), and (H) in FIG. 3.

To be more precise, in the period from time 1 to time 5, commands are supplied from the register 4 via the sequencer 6 and the card I/F 9 to the memory card 3, which is indicated as data signal (J). In the period from time 6 through time 14, addresses 1 through 3 are supplied as data signal (J) from the register 4 via the sequencer 6 and the card I/F 9 to the memory card 3.

In the period from time 15 to 16, the memory card, to which the address 3 has been supplied, falls in the busy state, as indicated by the pulse signal (K). During this period, the first output data 1 is prepared. When the first output data 1 has been prepared, the memory card 3 is released from the busy state at time 16, as indicated by the pulse signal (K).

The sequencer 6 then recognizes the release from the busy state of the memory card 3 from the input information effective signal (I). During the period from time 18 to time 19, the data 1 is supplied from the memory card 3 via the card I/F 9 and the sequencer 6 to the register 4.

After the data 1 is output, the read enable signal RE” rises at time 20 and then falls, as indicated by the pulse signal (G). At the falling edge of the read enable signal “-RE”, the data 2 is output from the memory card 3 via the sequencer 6 and the register 4 to the register 4 in the period from time 21 through time 22.

Under the interface timing control shown in FIG. 3, the data sets are successively read from designated addresses of the memory card 3.

Returning to FIG. 1, the input/output data bit control unit 8 sets the number of data bits of the data signal transmitted between the sequencer 6 and the memory card 3 via the card I/F 9 to one of 1, 4, and 8, depending on the card type. If the memory card 3 is a compact flash card, then the number of data bits may be controlled to sixteen (16).

This arrangement can deal with the situation where the number of data bits differs depending on the type of memory card, and in addition, there are several data bit numbers acceptable in the same type of memory card.

Card I/F 9 is an interface between the sequencer 6 and the memory card 3. The card detector 10 detects the type of the memory card 3 inserted in the memory card connector. The detection result is output from the card detector 10 to the host 2, the input/output data bit control unit 8, and the clock generator 12.

The clock generator 12 generates a timing clock for defining the operation cycle of the sequencer 6, and supplies the timing clock to the sequencer 6. The clock generator 12 can control the clock cycle of the timing clock. For instance, upon receiving the type of the memory card 3 inserted in the memory card connector, the clock generator 12 determines the clock cycle based on the detected card type. The clock generator 12 may also change the clock cycle based on the control data supplied from the sequencer 7.

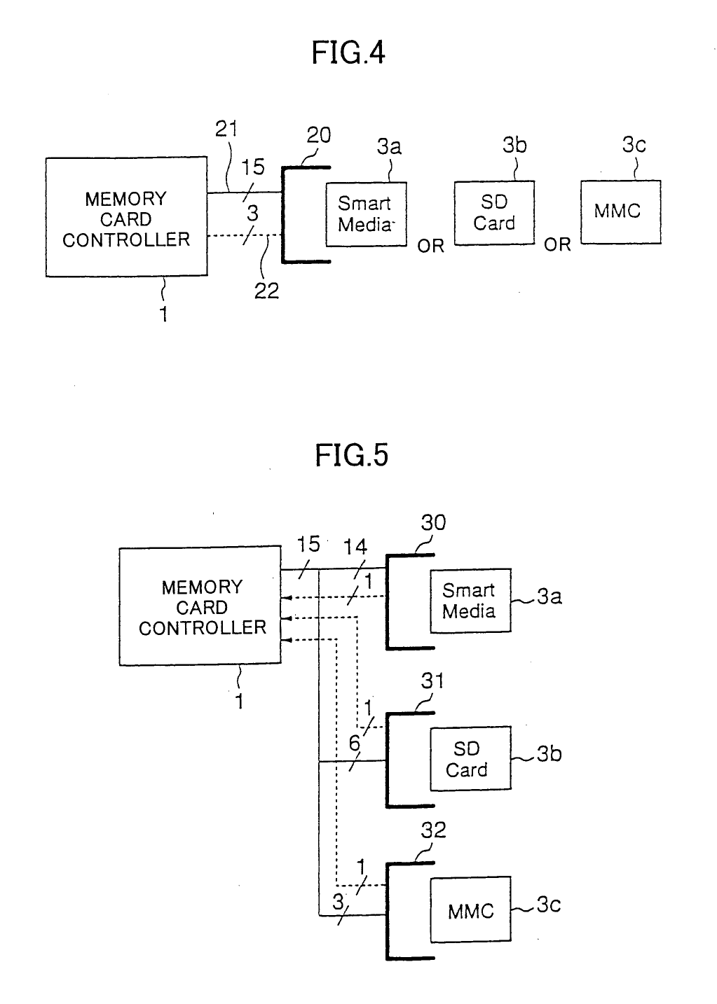

The memory card 3 is inserted in a memory card connector for electrical connection with the memory card controller 1, as illustrated in FIG. 4 and FIG. 5. FIG. 4 and FIG. 5 illustrate examples of connection structure between the memory card 3 and the memory card controller 1.

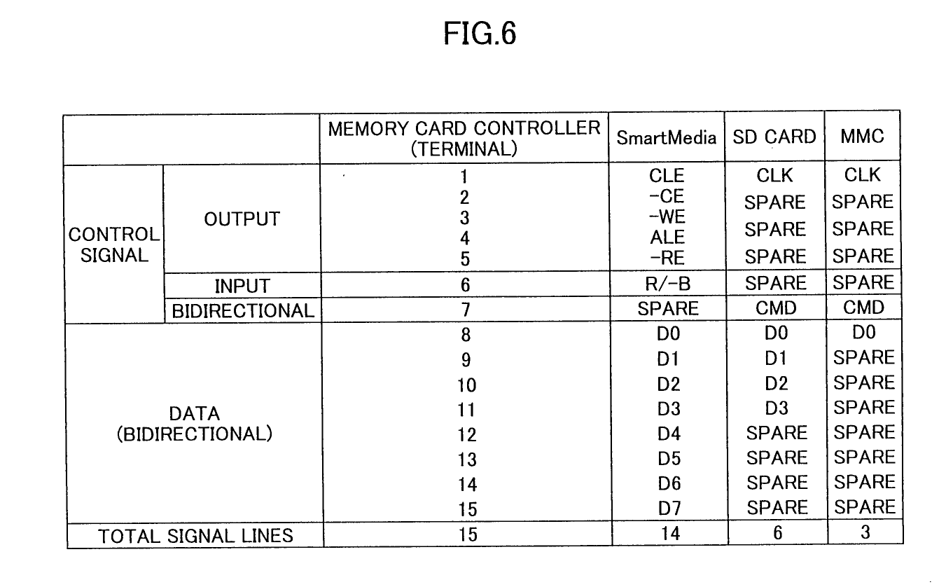

The memory card connector 20 illustrated in FIG. 4 is a so-called three-in-one connector that is capable of receiving Smart Media card 3a, SD card 3b, and MMC 3c. The memory card connector 20 is connected to the memory card controller 1 via a bundle of signal lines 21 and the card detection signal line 22. Signal functions are allocated to the bundle of signal lines 21 depending on the type of memory card 3, as illustrated in FIG. 6.

FIG. 6 illustrates an example of allocation of functions to the signal lines 21 between the memory card controller 1 and the memory card 3, where connections between the signal terminals of the memory card controller 1 and each of the Smart Media card, SD card, and MMC are shown. Depending on the type of the memory card 3, different functions are allocated to the associated signal lines. For example, when a Smart Media card is inserted in the connector 20, the first output terminal of the memory card controller 1 is connected to the command line enable signal terminal of the Smart Media card in order to supply a corresponding control signal through this signal line to the Smart Media card. If the SD card is connected to the memory card controller 1, the first output terminal of the memory card controller 1 is connected to the clock signal terminal of the SD card to supply a clock control signal to the SD card. Similarly, if an MMC is connected to the memory card controller 1, the first output terminal of the memory card controller 1 is connected to the clock terminal of the MMC to supply a corresponding clock control signal.

Through the card detection signal line 22, a card detection signal representing the type of the memory card inserted in the memory card connector 20 is supplied from the memory card connector 20 to the card detector 10 of the memory card controller 1.

On the other hand, each of the memory card connectors 30-32 shown in FIG. 5 is configured to receive one of the Smart Media card 3a, the SD card 3b, and the MMC 3c. The memory card connector 30 is designed for the Smart Media card 3a, and it is connected to the memory card controller 1 via fourteen (14) signal lines and a card detection signal line.

The memory card connector 31 is designed for the SD card 3b, and it is connected to the memory card controller 1 via six (6) signal lines and a card detection signal line. The memory card connector 32 is designed for the MMC 3c, and it is connected to the memory card controller 1 via three (3) signal lines and a card detection signal line. Each of the memory card connectors 30, 31, and 32 supplies a card detection signal to the card detector 10 of the memory card controller 1 upon receiving one of the memory cards 3a-3c.

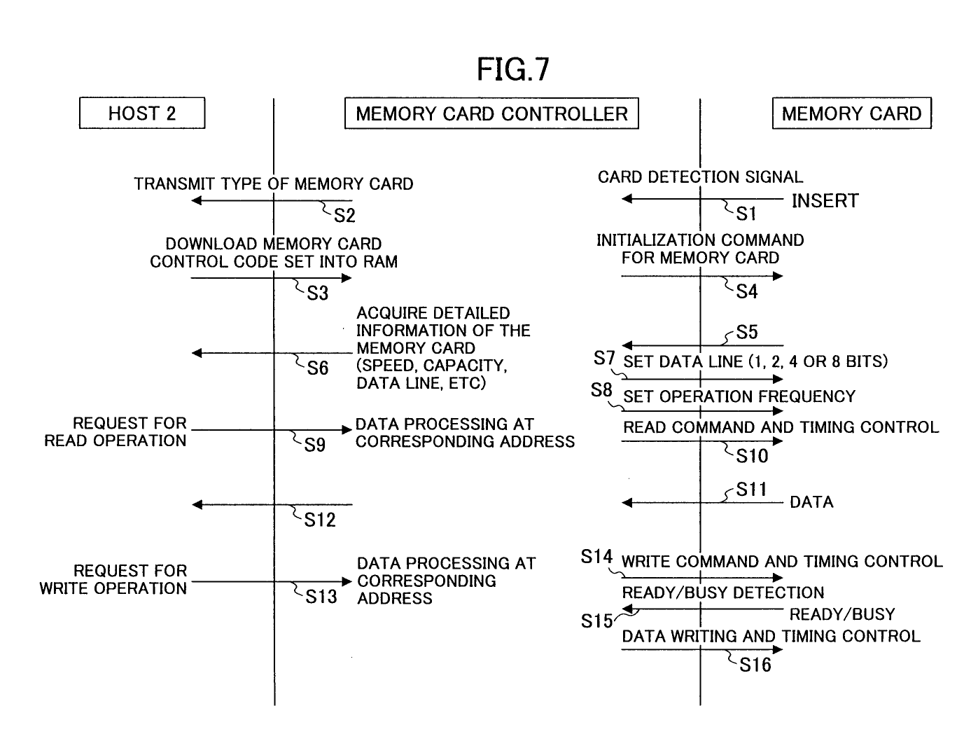

Next, the operations of the memory card controller according to the present invention will be explained with reference to FIG. 7. FIG. 7 is a sequence diagram showing the process sequences of the memory card controller 1.

In step S1, when the memory card 3 is inserted in, for example, the memory card connector 20, a card detection signal is supplied to the card detector 10 of the memory card controller 1. Then, in step S2, the card detector 10 determines the type of the memory card inserted in the memory card connector, based on the card detection signal, and outputs the determined card type to the host 2, as well as to the input/output data bit controller 8 and the clock generator 12.

The process proceeds to step S3, in which the program stored in the App memory 11 of the host 2 selects a set of card control codes in accordance with the type of the memory card supplied from the card detector 10. The selected set of card control codes is downloaded to the RAM 7 of the memory card controller 1 via the memory I/F 5.

Step S4 follows step S3. The sequencer 6 supplies the address determined unambiguously from the initialization command for the memory card inserted in the memory card connector to the RAM 7, and successively reads the set of card control codes, corresponding to the initialization command, from the RAM 7. The sequencer 6 then supplies signals generated according to the card control codes read from the RAM 7 to the memory card 3 via the card I/F 9.

In step S5, following step S4, the memory card 3 performs initialization in response to the initialization command, and supplies memory card detailed information, including the speed, the capacity, and the data signal bit width, to the memory card controller 1. The memory card detailed information supplied to the memory card controller 1 is forwarded to the register 4, via the card I/F 9 and the sequencer 6. The memory card detailed information is analyzed in the sequencer 6.

The process proceeds to step S6 after step S5, the sequencer 6 causes the memory card detailed information to be transmitted from the register 4 to the host 2. Then, in step S7, the sequencer 6 supplies the data signal bit width extracted from the memory card detail information to the input/output data bit controller 8. The input/output data bit controller 8 controls the bit width of the data signal to, for example, 1, 4, 8, or 16 bits.

Step S7 is followed by step S8, in which the sequencer 6 supplies the speed information extracted from the memory card detailed information to the clock generator in order to control the memory card 3 received in the memory card connector, at the optimum timing of control signal.

The process in and after step S9 differs depending on the operation request supplied from the host 2. As an example, explanation is made below of the process carried out when a read request and a write request are supplied from the host 2.

In step S9, a request for read operation is supplied from the host 2 to the register 4 of the memory card controller 1. This read request contains, for example, a read command and an address. The sequencer 6 successively reads a set of card control codes that corresponds to the read command from the RAM 7. Then in step S10, the sequencer 6 outputs control signals, which are generated based on the card control code set read in step S9, as well as the read command and the address stored in the register 4, to the memory card 3.

The process proceeds to step S11. The memory card 3 reads data in response to the control signal, the read command, and the address supplied from the memory card controller 1, and supplies the data to the memory card controller 1. Then in step S12, the memory card controller 1 outputs the data received from the memory card 3 to the host 2, via the card I/F 9, the sequencer 6, and the register 4.

In step S13, a write request is supplied from the host 2 to the register 4 of the memory card controller 1. The write request contains, for example, a write command, an address, and data. The sequencer 6 successively reads a set of card control codes from the RAM 7, corresponding to the write command. Then, in step S14, the sequencer 6 outputs the control signals generated based on the card control code set read in step S13, as well as the write command and the address stored in the register 4, to the memory card 3.

The memory card 3 receives the control signal the write command, and the address from the memory card controller 1. Then, in step S15, the memory card 3 generates and supplies a ready/busy signal R/-B to the memory card controller 1, in response to the control signal, the write command and the address. Step S16 follows step S15, the memory card controller 1 transmits the data to be written to the memory card 3, based on the ready/busy signal R/-B.

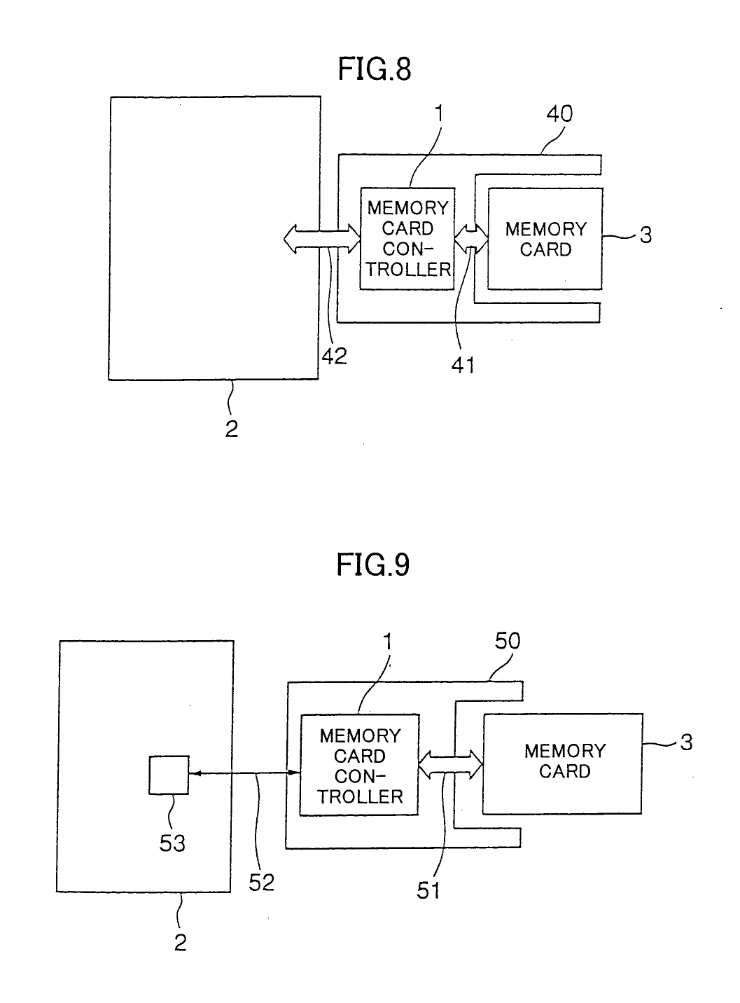

FIG. 8 illustrates an example of the storage medium adaptor that incorporates the memory card controller 1 according to an embodiment of the invention.

In this example, the memory card controller 1 is assembled into a memory card adaptor 40. The memory card controller 1 is connected to the memory card 3 via the memory card connector 41, and at the same time, connected to the host 2 via the memory card slot 42. The operations of the memory card controller 1, the host 2, and the memory card 3 are the same as the above-described operations, and therefore, the explanation for them will be omitted.

FIG. 9 illustrates another example of the memory card adaptor that incorporates the memory card controller 1 according to an embodiment of the invention.

As in the example shown in FIG. 8, the memory card controller 1 is assembled in the memory card adaptor 50. The memory card controller 1 is connected to the memory card 3 via the memory card connector 51, and at the same time, connected to the serial controller 53 of the host 2, via the serial port 52. The operations of the memory card controller 1, the host 2, and the memory card 3 are the same as those described above.

In this manner, upon insertion of the memory card, the type of the memory card is detected, and a set of card control codes is acquired from the host, in accordance with the detected type of the memory card. Since the card control codes stored in the host are expressed by each bit, the card control codes can be modified easily, and a new set of card control codes can be added easily.

In addition, the memory card controller 1 does not have to maintain the card control code sets in it because it can receive an appropriate set of card control codes consistent with the type of the inserted memory card from the host. Consequently, the memory card controller is capable of dealing with various types of memory cards, without causing the circuit structure to be complicated.

Also, the memory card controller can be realized by an integrated circuit with a smaller number of devices, and electric power consumption can be reduced.

In the above-described example of the operation sequences shown in FIG. 7, the sequencer 6 controls the bit width of the data signal for the input/output data bit controller 8 in step S7, and it controls the clock generator 12 in step S8 based on the speed information extracted from the memory card detailed information. However, the host 2 may analyze the memory card detailed information in step S6 after it received the information from the memory card controller 1. In this case, the host 2 controls the input/output data bit controller 8 and the clock generator 12.

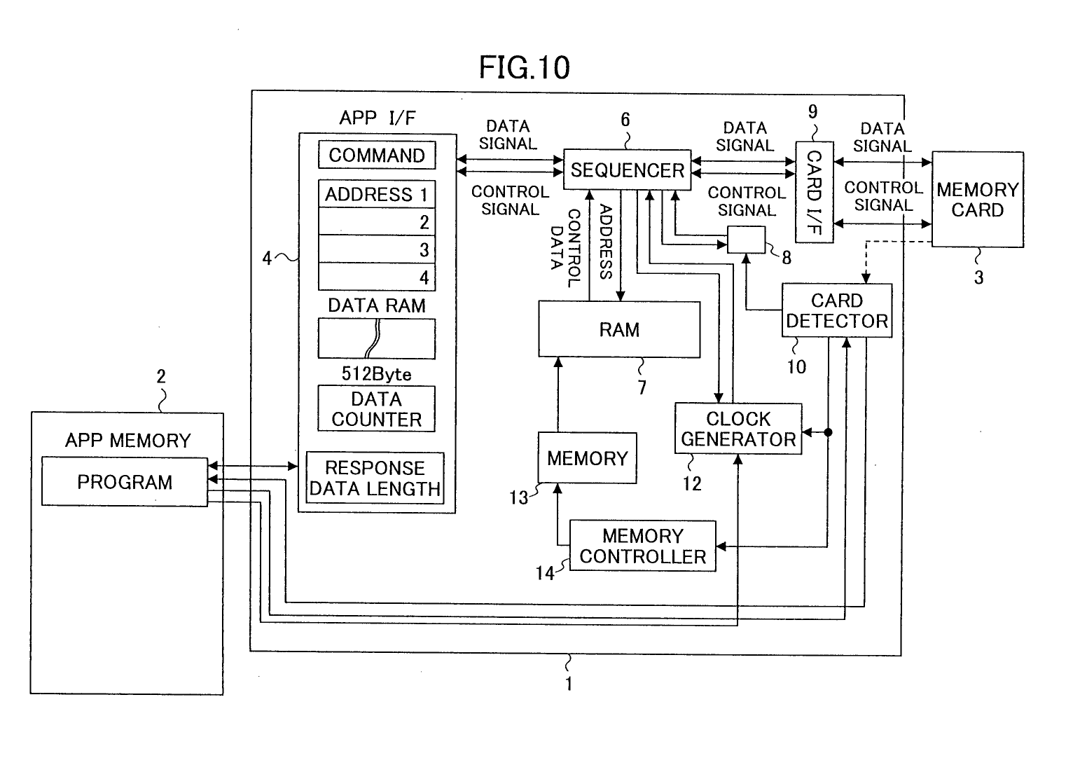

FIG. 10 illustrates a modification of the memory card controller 1. In the previous example, the host 2 has various sets of card control codes. In the example shown in FIG. 10, the memory card controller 1 is configured to store sets of card control codes in the memory 13 (such as ROM or EPROM). The memory controller 14 reads a desired set of card control codes from the memory 13 in accordance with the card type detected by the card detector, and supplies the card control codes to the RAM 7. Alternatively, the RAM 7 may be replaced by a nonvolatile memory, such as a ROM or an EPROM, so as to retain the card control code sets.

The card control code set shown in FIG. 2 is an example of state information. Signal functions allocated to signal lines between the memory card controller and the memory card shown in FIG. 6 is an example of functional information. The state information and the functional information are expressed by each bit, and used to control the signals and their timing transmitted through the signal lines.

The memory card controller 1 is an example of a storage medium control device. The sequencer 6 is an example of the timing controller. The card detector 10 is an example of the detection signal generator. The memory card adaptors 40 and 50 are examples of the storage medium adaptor. The memory card connectors 41 and 51 are examples of the first connector for receiving a memory card (or a storage medium) in a removable or detachable manner. The memory card slot 42 and the serial port 52 are examples of the second connector for connecting the memory card controller to the host.

These elements explained in the above-described embodiments are only illustrative examples, and there are many modification and substitutions within the scope of the present invention.

What is claimed is:

1. A storage medium control method carried out in a storage medium control device inserted between a storage medium and a host apparatus that accesses the storage medium to control signal lines connected between the storage medium control device and the storage medium in a detachable manner, as well as timing of signals on the signal lines, the method comprising the steps of:
reading functional information of the signal lines used to control the storage medium, and state information of the signals on the signal lines from first storage means in accordance with a type of the storage medium; and
controlling the timing of the signals passing between the storage medium and the storage medium control device, based on an operation clock and the state information, in response to an operation request supplied from the host apparatus.

2. The storage medium control method according to claim 1, wherein the functional information of the signal line and the state information of the signal on the signal line constitute state control information, and the state control information defines the function of each of the signal lines and a state of each of the signals on the signal lines by each bit.

3. The storage medium control method according to claim 2, further comprising the step of:
detecting connection of the storage medium to the storage medium control device to produce a detection signal consistent with the type of the storage medium, wherein the timing control step includes:
controlling a period of the operation clock based on the detection signal or the state information in order to control the timing of the signal.

4. The storage medium control method according to claim 2, further comprising the step of:
detecting connection of the storage medium to the storage medium control device to produce a detection signal representing the type of the storage medium, wherein the information reading step includes:
selecting a set of state control information containing the functional information of the signal lines that is consistent with the detected type of the storage medium, from among multiple sets of the state control information stored in the first storage means.

5. The storage medium control method according to claim 2, further comprising the step of:
detecting connection of the storage medium to the storage medium control device to produce a detection signal representing the type of the storage medium, wherein the information reading step includes:
selecting a set of state control information containing the functional information of the signal lines consistent with the detected type of the storage medium, from among multiple sets of the state control information stored in second storage means and causing the selected set of state control information to be stored in the first storage means.

6. The storage medium control method according to claim 2, further comprising:
detecting connection of the storage medium to the storage medium control device to produce a detection signal representing the type of the storage medium, wherein the information reading step includes:
receiving the functional information of the signal lines that is consistent with the detection signal and the state information of the signals on the signal lines from the host apparatus, and
storing the received functional information and the state information in the first storage means.

7. The storage medium control method according to claim 2, wherein the storage medium is a memory card comprising a flash memory.

8. The storage medium control method according to claim 2, wherein the timing control step includes:
specifying a start address of the state information in response to the operation request from the host apparatus; and
determining a function and an input and output direction of each of the signals, based on the operation clock and the state information with the start address specified.

9. A storage medium control device inserted between a storage medium and a host apparatus that accesses the storage medium, to control signal lines connected to the storage medium in a detachable manner, as well as timing of signals on the signal lines, the storage medium control device comprising:
a first storage that stores functional information of the signal lines for controlling the storage medium, and state information of the signals on the signal lines, in association with a type of the storage medium; and
a timing controller that controls the timing of the signals passing between the storage medium and the storage medium control device, based on an operation clock and the state information, in response to an operation request supplied from the host apparatus.

10. The storage medium control device according to claim 9, wherein the functional information of the signal lines and the state information of the signals on the signal lines constitute state control information, and the state control information defines the function of each of the signal lines and a state of each of the signals on the signal lines by each bit.

11. The storage medium control device according to claim 10, further comprising:
a detection signal generator that detects connection of the storage medium to the storage medium control device and produces a detection signal consistent with the type of the storage medium; and
a clock generator that generates the operation clock, while controlling a period of the operation clock based on the detection signal or the state information, wherein the timing controller controls the timing of the signals on the signal lines using the period of the operation clock.

12. The storage medium control device according to claim 10, further comprising:
a detection signal generator that detects connection of the storage medium to the storage medium control device and produces a detection signal representing the type of the storage medium; and
a selector that selects a set of state control information containing the functional information of the signal lines that is consistent with the detected type of the storage medium, from among multiple sets of the state control information stored in the first storage.

13. The storage medium control device according to claim 10, further comprising:
a detection signal generator that detects connection of the storage medium to the storage medium control device and produces a detection signal representing the type of the storage medium; and
a selector that selects a set of state control information containing the functional information of the signal lines consistent with the detected type of the storage medium, from among multiple sets of the state control information stored in a second storage, and that causes the selected set of state control information to be stored in the first storage.

14. The storage medium control device according to claim 10, further comprising:
a detection signal generator that detects connection of the storage medium to the storage medium control device and produces a detection signal representing the type of the storage medium; and
an interface that requests the host apparatus to supply the functional information of the signal lines that is consistent with the detection signal and the state information of the signals on the signal lines, and causes the received functional information and the state information to be stored in the first storage.

15. The storage medium control device according to claim 10, wherein the storage medium is a memory card comprising a flash memory.

16. The storage medium control device according to claim 10, further comprising:
start address specifying means connected to the first storage and for specifying a start address of the state information, in response to the operation request from the host apparatus; and
control signal specifying means for determining a function and an input and output direction of each of the signals based on the operation clock and the state information with the start address specified.

17. A storage medium adaptor electrically connected between a storage medium and a host apparatus that accesses the storage medium, the storage medium adaptor controlling signal lines connected to the storage medium in a detachable manner and timing for signals on the signal lines, the storage medium adaptor comprising:
a first connector that receives the storage medium in a removable manner;
a second connector that establishes connection with the host apparatus;
a first storage that stores functional information of the signal lines used to control the storage medium, and state information of the signals on the signal lines, in association with a type of the storage medium; and
a timing controller that reads the functional information of the signal lines and the state information of the signals from the first storage, and controls the timing of the signals passing between the storage medium and the host apparatus based on an operation clock and the state information, in response to an operation request supplied from the host apparatus.

18. The storage medium adaptor according to claim 17, wherein the functional information of the signal lines and the state information of the signals on the signal lines constitutes state control information, and the state control information defines the function of each of the signal lines and a state of each of the signals on the signal lines by each bit.

19. The storage medium adaptor according to claim 18, further comprising:
a detection signal generator that detects connection of the storage medium to the storage medium control device and produces a detection signal consistent with the type of the storage medium; and
a clock generator that generates the operation clock, while controlling a period of the operation clock based on the detection signal or the state information, wherein the timing controller controls the timing of the signals on the signal lines using the period of the operation clock.

20. The storage medium adaptor according to claim 18, further comprising:
a detection signal generator that detects connection of the storage medium to the storage medium control device and produces a detection signal representing the type of the storage medium; and
a selector that selects a set of state control information containing the functional information of the signal lines that is consistent with the detected type of the storage medium, from among multiple sets of the state control information stored in the first storage.

21. The storage medium adaptor according to claim 18, further comprising:
a detection signal generator that detects connection of the storage medium to the storage medium control device and produces a detection signal representing the type of the storage medium; and
a selector that selects a set of state control information containing the functional information of the signal lines consistent with the detected type of the storage medium, from among multiple sets of the state control information stored in a second storage, and that causes the selected set of state control information to be stored in the first storage.

22. The storage medium adaptor according to claim 18, further comprising:
a detection signal generator that detects connection of the storage medium to the storage medium control device and produces a detection signal representing the type of the storage medium; and
an interface that requests the host apparatus to supply the functional information of the signal lines that is consistent with the detection signal and the state information of the signals on the signal lines, and causes the received functional information and the state information to be stored in the first storage.

23. The storage medium control adaptor according to claim 18, wherein the storage medium is a memory card comprising a flash memory.

24. The storage medium adaptor according to claim 18, further comprising:
start address specifying means connected to the first storage and for specifying a start address of the state information, in response to the operation request from the host apparatus; and
control signal specifying means for determining a function and an input and output direction of each of the signals based on the operation clock and the state information with the start address specified.
